(19) United States
(12) Patent Application Publication
(10) Pub. No.: US 2012/0140661 A1
(43) Pub. Date: Jun. 7, 2012

(54) Communication Quality Estimation Apparatus, Base Station Apparatus, Communication Quality Estimation Method, and Communication Quality Estimation Program

(75) Inventors: Takeo OHSEKI, Fujimino-shi (JP); Satoshi KONISHI, Fujimino-shi (JP)

(73) Assignee: KDDI Corporation

(21) Appl. No.: 13/311,196

(22) Filed: Dec. 5, 2011

(30) Foreign Application Priority Data
Dec. 6, 2010 (JP) 2010-271724

(51) Int. Cl. H04W 24/00

(52) U.S. Cl. 370/252

(57) ABSTRACT

A communication quality estimation apparatus includes a channel information acquisition section for receiving channel quality information indicating channel quality in transmission paths between a plurality of terminal apparatuses and a base station apparatus from the plurality of terminal apparatuses for each subframe, a smoothing calculation section for calculating smoothed channel quality information by smoothing the channel quality information received so far from the terminal apparatus for each terminal apparatus, and a smoothed information storage section for storing the smoothed channel quality information calculated by the smoothing calculation section in association with an identifier of each of the plurality of terminal apparatuses.

### CROSS-REFERENCE TO RELATED APPLICATIONS

Priority is claimed on Japanese Patent Application No. 2010-271724, filed Dec. 6, 2010, the content of which is incorporated herein by reference.

### BACKGROUND OF THE INVENTION

1. Field of the Invention

The present invention relates to a communication quality estimation apparatus, a base station apparatus, a communication quality estimation method, and a communication quality estimation program.

2. Description of Related Art

As a next-generation mobile communication type system, a long-term evolution (LTE) standard of the Third Generation Partnership Project (3GPP) for implementing high-speed/wideband transmission has been described, for example, in 3GPP TS36.211, “Evolved Universal Terrestrial Radio Access (E-UTRA); Physical channels and modulation,” 2009-12, and in 3GPP TS36.213, “Evolved Universal Terrestrial Radio Access (E-UTRA); Physical layer procedures,” 2009-09. In the LTE standard, an orthogonal frequency division multiple access (OFDMA) type system has been adopted as a transmission type of downlink (link from a base station apparatus to a terminal apparatus).

The OFDMA type system is one of multicarrier transmission system types in which communication is performed using a wideband signal including a plurality of subcarriers of which frequencies are orthogonal to each other. In the OFDMA type system, a different subcarrier for each user (terminal apparatus) is used, so that a multiple access process of connecting one base station apparatus and a plurality of terminal apparatuses is implemented.

In the OFDMA type system, the base station apparatus allocates subcarriers to the terminal apparatus on the basis of channel quality information (a channel quality indicator (CQI)) indicating channel quality between the base station apparatus and the terminal apparatus fed back from the terminal apparatus. A process in which the base station apparatus allocates subcarriers to the terminal apparatus is referred to as radio scheduling, and a radio scheduler provided in the base station apparatus is responsible for the function of radio scheduling.

FIGS. 7A and 7B are diagrams showing an example of a radio frame configuration of the downlink in the OFDMA type system. A radio frame shown in FIG. 7A is based on the LTE standard, and includes a plurality of subframes. In general, the LTE radio scheduler performs radio scheduling in units of subframes (each corresponding to 1 ms).

The radio scheduler of the downlink performs the radio scheduling based on channel quality information fed back by the terminal apparatus to the base station apparatus. In LTE, two CQIs including a CQI for the entire frequency band of a system and a CQI for a frequency band in a part of the system band are fed back. The former is referred to as a wideband CQI and the latter is referred to as a subband CQI.

FIG. 7B is a diagram showing an example of a subband in the LTE. In the example of the same drawing, a system bandwidth is 10 MHz and the number of resource blocks (RBs) is 50. An RB is a minimum unit of allocation on a frequency axis of radio scheduling in a set of subcarriers. Further, as shown in the same drawing, a subband size is 6 RBs. At this time, the subband CQI indicates channel quality corresponding to an RB (frequency band) allocated to the subband.

In the LTE, a standard to which multiple-input multiple-output (MIMO) is applied is defined. The MIMO is largely classified into two MIMO types. One type is closed-loop MIMO in which precoding information selected by the terminal apparatus is fed back to the base station apparatus using an uplink, and the base station apparatus determines an amplitude and phase of data to be transmitted from each antenna using the fed back precoding information.

The other type is open-loop MIMO in which an amplitude and phase of data to be transmitted from each antenna are determined using information obtained in the base station apparatus without using precoding information from the terminal apparatus.

The precoding information is indicated using a precoding matrix indicator (PMI) for identifying a precoding matrix included in a codebook prepared in the base station apparatus and the terminal apparatus in the LTE.

### DETAILED DESCRIPTION OF THE INVENTION

However, in the LTE standard, a CQI fed back by the terminal apparatus in an n^{th} subframe is determined using only channel quality of an (n−4)^{th} subframe under a specification. Thus, when a temporary change is large in a transmission path environment if the radio scheduler performs radio scheduling using a CQI that was four subframes ago (4 [ms] ago), radio scheduling corresponding to the transmission path environment is not performed.

For example, if the base station apparatus performs radio scheduling in an n^{th} subframe for the terminal apparatus when interference from a neighboring base station apparatus or another terminal apparatus is varied for every subframe, channel quality indicated by the CQI of the (n−4)^{th} subframe based on the radio scheduling is likely to be different from the channel quality of the n^{th} subframe. Thus, a reception error rate in the terminal apparatus does not reach a target value even when the radio scheduler performs the radio scheduling to achieve the target value.

In addition, in an OFDMA cellular system, when the same subband as a subband allocated to a terminal apparatus located around a boundary of a neighboring sector is allocated to a terminal apparatus connected to a base station apparatus of the neighboring sector, terminal apparatuses interfere with each other. Because this interference occurs only when downlink transmissions for terminal apparatuses are performed in the same subframe, the CQI is greatly changed according to the presence/absence of transmission by the base station apparatus of the neighboring sector. Because the presence/absence of transmission of the base station apparatus is generally changed for every subframe, it may not be possible to allocate a radio resource corresponding to channel quality during transmission in the radio scheduling using the CQI of the (n−4)^{th} subframe. The above-described interference change is noticeable in an environment in which an amount of traffic of the downlink of the base station apparatus of the neighboring sector is not unduly large, and becomes one factor in which the radio scheduling corresponding to the transmission path environment is not performed.

In addition, in the OFDMA cellular system adopting the closed-loop MIMO, the terminal apparatus feeds back a CQI and a PMI to the base station apparatus. At this time, the fed-back CQI is a CQI under assumption that a precoding matrix indicated by the PMI to be used for the downlink is used. In addition, the radio scheduling is performed under assumption that interference received from the neighboring sector is substantially the same as interference when the fed-back CQI and PMI are determined. Thus, if the closed-loop MIMO is also applied to the same subband of the neighboring sector, the interference in the subband is greatly varied when the PMI changes in the same subband of the neighboring sector.

For example, a terminal apparatus A calculates a CQI and a PMI in a subframe in which a terminal apparatus B scheduled in the same subband of the neighboring sector has used PMI=0. Thereafter, if a terminal apparatus C scheduled in the same subband of the neighboring sector performs transmission using PMI=1 in a subframe to be transmitted using the CQI and PMI calculated by the terminal apparatus A, the interference in the terminal apparatus A is greatly varied. As described above, the radio scheduler does not achieve the target value of the reception error rate and radio scheduling corresponding to the transmission path environment is not performed even when the radio scheduling is performed on the basis of the fed-back CQI and PMI.

As described above, if a difference due to the presence/absence of interference or the like occurs between channel quality indicated by information (a CQI) used for the radio scheduling and channel quality in a transmission path environment when communication is performed using a result of radio scheduling using the information, there is a problem in that radio scheduling corresponding to the transmission path environment is not performed.

The present invention has been made to solve the above-described problem, and an object of the invention is to provide a communication quality estimation apparatus, a base station apparatus, a communication quality estimation method, and a communication quality estimation program capable of reducing a difference between channel quality indicated by information used for radio scheduling and channel quality during communication based on a result of the radio scheduling.

### SUMMARY OF THE INVENTION

According to the present invention for solving the above-described problem, there is provided a communication quality estimation apparatus including: a channel information acquisition section configured to receive channel quality information indicating channel quality in transmission paths between a plurality of terminal apparatuses and a base station apparatus from the plurality of terminal apparatuses for each subframe; a smoothing calculation section configured to calculate smoothed channel quality information by smoothing the channel quality information received so far from a terminal apparatus for each terminal apparatus; and a smoothed information storage section configured to store the smoothed channel quality information calculated by the smoothing calculation section in association with an identifier (ID) of each of the plurality of terminal apparatuses.

In the present invention described above, the terminal apparatus and the base station apparatus perform wireless communication using any one of a plurality of predetermined frequency bands, the smoothing calculation section further calculates the smoothed channel quality information for each combination of the terminal apparatus and the frequency band, and the smoothed information storage section stores the smoothed channel quality information in association with each combination of the terminal apparatus and the frequency band.

In the present invention described above, the terminal apparatus and the base station apparatus perform wireless communication to which closed-loop MIMO is applied, the smoothing calculation section further calculates the smoothed channel quality information for each combination of the number of signal sequences to be transmitted in parallel and IDs for identifying the signal sequences, and the smoothed information storage section further stores the smoothed channel quality information in association with each combination of the number of signal sequences to be transmitted in parallel and the IDs for identifying the signal sequences.

In the present invention described above, the smoothing calculation section performs an update process of multiplying each of channel quality information received in a current subframe and the smoothed channel quality information of a terminal apparatus corresponding to the channel quality information by a predetermined forgetting factor and setting a sum of the multiplication results to new smoothed channel quality information for every subframe.

In the present invention described above, if no channel quality information is received in the current subframe, the smoothing calculation section performs an update process of multiplying each of last received channel quality information and the smoothed channel quality information of a terminal apparatus corresponding to the channel quality information by the forgetting factor and setting a sum of the multiplication results to new smoothed channel quality information for every subframe.

In the present invention described above, when a predetermined period has elapsed after last channel quality information has been received if no channel quality information is received in the current subframe, the smoothing calculation section performs an update process of multiplying each of a predetermined initial value and the smoothed channel quality information by the forgetting factor and setting a sum of the multiplication results to new smoothed channel quality information for every subframe.

In the present invention described above, the smoothing calculation section selects any one of a plurality of predetermined forgetting factors on the basis of an amount of variation of a carrier frequency occurring due to movement of the terminal apparatus, and updates the smoothed channel quality information using the selected forgetting factor.

In the present invention described above, the smoothing calculation section selects any one of a plurality of predetermined forgetting factors on the basis of radio-resource utilization in a base station apparatus neighboring the base station apparatus, and updates the smoothed channel quality information using the selected forgetting factor.

In the invention described above, the smoothing calculation section selects any one of a plurality of predetermined forgetting factors on the basis of a ratio of terminal apparatuses that perform communication using closed-loop MIMO, among terminal apparatuses that communicate with a base station apparatus neighboring the base station apparatus, and updates the smoothed channel quality information using the selected forgetting factor.

According to the present invention, there is provided a base station apparatus including: a channel information acquisition section configured to receive channel quality information indicating channel quality in transmission paths between a plurality of terminal apparatuses and the base station apparatus from the plurality of terminal apparatuses for each subframe; a smoothing calculation section configured to calculate smoothed channel quality information by smoothing the channel quality information received so far from a terminal apparatus for each terminal apparatus; a smoothed information storage section configured to store the smoothed channel quality information calculated by the smoothing calculation section in association with an ID of each of the plurality of terminal apparatuses; a radio scheduler configured to allocate radio resources to the plurality of terminal apparatuses using the smoothed channel quality information corresponding to each of the plurality of terminal apparatuses; and a wireless transmission/reception section configured to communicate with the plurality of terminal apparatuses using the radio sources allocated by the radio scheduler to the plurality of terminal apparatuses.

According to the present invention, there is provided a communication quality estimation method including the steps of: receiving channel quality information indicating channel quality in transmission paths between a plurality of terminal apparatuses and a base station apparatus from the plurality of terminal apparatuses for each subframe; calculating smoothed channel quality information by smoothing the channel quality information received so far from a terminal apparatus for each terminal apparatus; and storing the calculated smoothed channel quality information in association with an ID of each of the plurality of terminal apparatuses.

According to the present invention, there is provided a communication quality estimation program for causing a computer to execute the step of: receiving channel quality information indicating channel quality in transmission paths between a plurality of terminal apparatuses and a base station apparatus from the plurality of terminal apparatuses for each subframe; calculating smoothed channel quality information by smoothing the channel quality information received so far from a terminal apparatus for each terminal apparatus; and storing the calculated smoothed channel quality information in association with an ID of each of the plurality of terminal apparatuses.

### Effects of the Invention

According to the present invention, channel quality information indicating channel quality of a transmission path with each of a plurality of terminal apparatuses is smoothed for each terminal apparatus and stored in a smoothed information storage section. Thereby, even when the channel quality has been temporarily changed due to interference or the like, it is possible to read the smoothed channel quality information reducing an influence of the temporary change by smoothing from the smoothed information storage section and use the read smoothed channel quality information for radio scheduling. As a result, it is possible to reduce a difference between channel quality indicated by smoothed channel quality information used for radio scheduling and channel quality during communication based on a result of the radio scheduling.

### BRIEF DESCRIPTION OF THE DRAWINGS

FIG. 1 is a schematic diagram showing a configuration of a wireless communication system according to a first embodiment;

FIG. 2 is a schematic block diagram showing a configuration of a base station apparatus according to the same embodiment;

FIG. 3 is a diagram showing an example of information stored in a smoothed signal-to-interference-plus-noise ratio (SINR) storage section according to the same embodiment;

FIG. 4 is a schematic block diagram showing a configuration of a base station apparatus according to a second embodiment;

FIG. 5 is a schematic block diagram showing a configuration of a base station apparatus according to a third embodiment;

FIG. 6A is a diagram showing advantageous effects by the base station apparatus according to the first embodiment;

FIG. 6B is a diagram showing advantageous effects by the base station apparatus according to the first embodiment;

FIG. 7A is a diagram showing an example of a radio frame configuration of downlink in an OFDMA type system; and

FIG. 7B is a diagram showing an example of a radio frame configuration of downlink in an OFDMA type system.

### DETAILED DESCRIPTION OF THE INVENTION

Hereinafter, a communication quality estimation apparatus, a base station apparatus, a communication quality estimation method, and a communication quality estimation program according to embodiments of the present invention will be described with reference to the drawings.

### First Embodiment

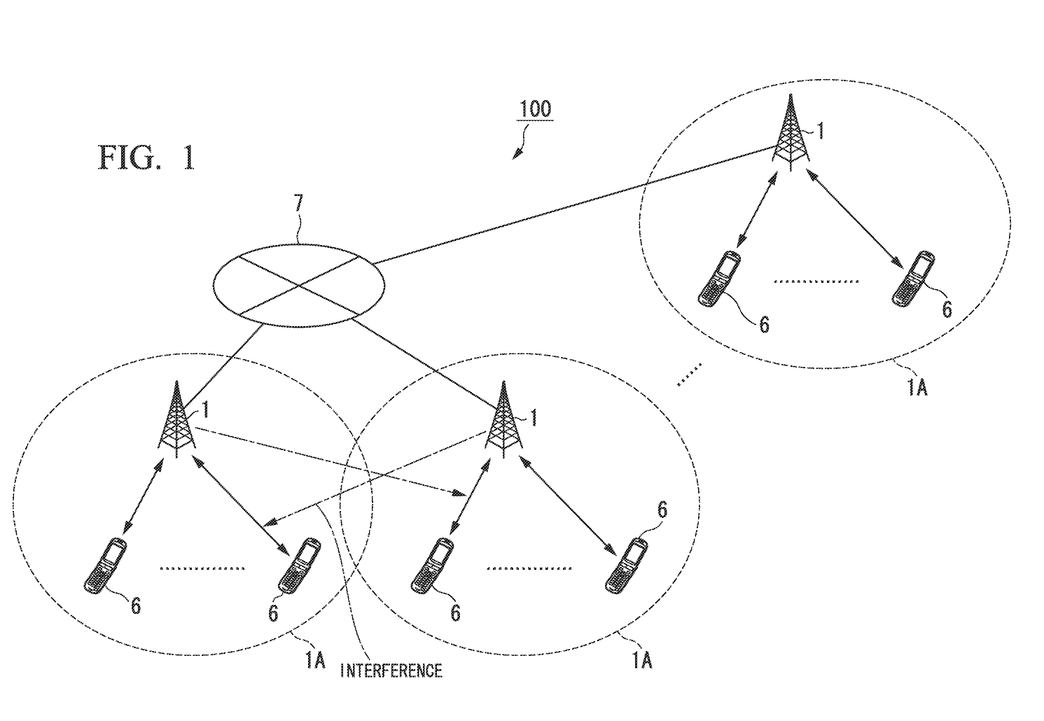

FIG. 1 is a schematic diagram showing a configuration of a wireless communication system 100 according to a first embodiment. As shown in the same drawing, the wireless communication system 100 includes a plurality of base station apparatuses 1, a plurality of terminal apparatuses 6, and a backbone network 7 for connecting the plurality of base station apparatuses 1. Each base station apparatus 1 forms a communication area 1A, and wirelessly communicates with the terminal apparatuses 6 located within the communication area 1A of its own apparatus. Here, an example in which closed-loop MIMO based on the LTE standard is applied to wireless communication between the base station apparatus 1 and the terminal apparatuses 6 will be described.

In addition, the base station apparatus 1 receives channel information from the terminal apparatuses 6 located within the communication area 1A (sector) of its own apparatus, and performs radio scheduling to allocate radio resources to the terminal apparatuses 6 in units of RBs on the basis of the received channel information. In addition, the base station apparatus 1 performs the radio scheduling in consideration of a change of channel quality due to interference or the like received from a terminal apparatus 6 located in a neighboring communication area 1A. In the figure, “Intr” indicates interference.

Here, the channel information includes a CQI as channel quality information indicating channel quality between the terminal apparatus 6 transmitting (feeding back) channel information and the base station apparatus 1, a terminal identifier (ID) for uniquely identifying the terminal apparatus 6, a rank indicator (RI) and a code word ID corresponding to the CQI, and band information indicating a frequency band for the CQI. The band information includes information indicating whether the CQI is a wideband CQI or a subband CQI and a subband ID indicating a corresponding subband when the CQI is a subband CQI.

The RI indicates the number of signal sequences transmitted in parallel in allocated radio resources (or a rank), and indicates a value of either “1” or “2” in this embodiment. The code word ID is an ID for identifying a signal transmitted in parallel in wireless communication to which MIMO of the base station apparatus 1 and the terminal apparatus 6 is applied, and indicates a value of either “0” or “1” in this embodiment.

In this embodiment, the number of subbands is set to N (N is a natural number), and the subband ID indicates any value of “0,” “1,” “N−1.”

Hereinafter, a configuration of the base station apparatus 1 will be described.

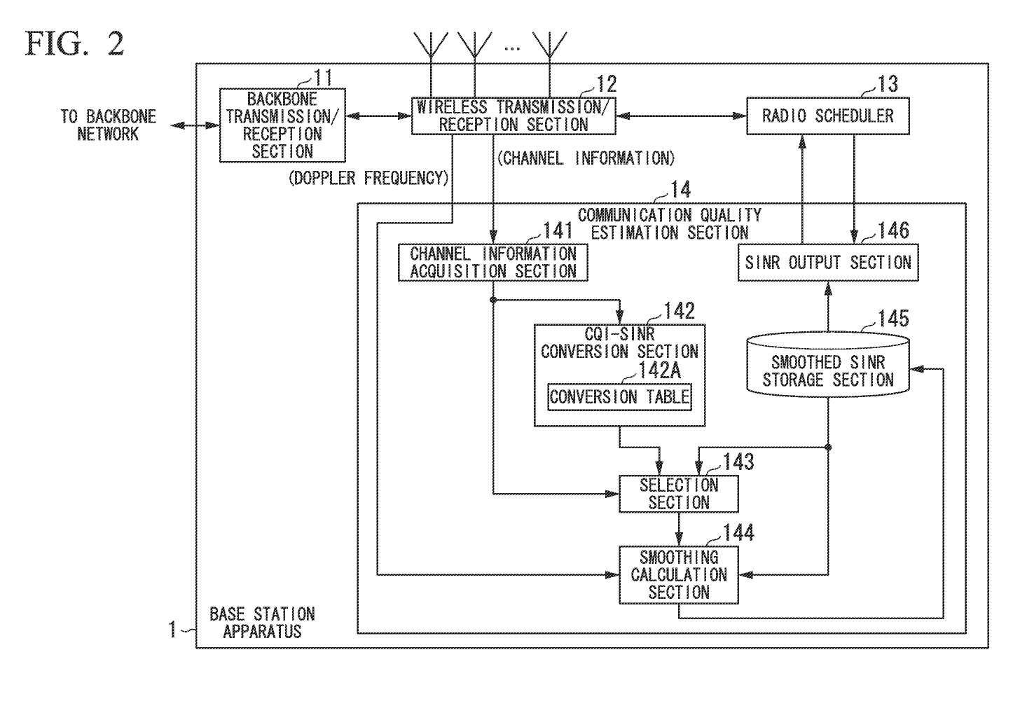

FIG. 2 is a schematic block diagram showing the configuration of the base station apparatus 1 according to this embodiment. As shown in the same drawing, the base station apparatus 1 includes a backbone transmission/reception section 11, which communicates with another base station apparatus 1 via the backbone network 7 (indicated as “BKN”), a wireless transmission/reception section 12, which communicates with the terminal apparatus 6, a radio scheduler 13, which performs radio scheduling for the terminal apparatus 6, and a communication quality estimation section 14, which calculates an SINR from channel information received from the terminal apparatus 6.

The backbone transmission/reception section 11 receives information addressed to a terminal apparatus 6 in which wireless communication with another base station apparatus 1 is ongoing from the wireless transmission/reception section 12, and transmits information input to the base station apparatus 1 in which wireless communication with the terminal apparatus 6 is ongoing. In addition, the backbone transmission/reception section 11 receives information addressed to a terminal apparatus 6 in which wireless communication with its own apparatus is ongoing from another base station apparatus 1 and outputs the received information to the wireless transmission/reception section 12.

The wireless transmission/reception section 12 wirelessly communicates with a terminal apparatus 6 located within the communication area 1A of its own apparatus via a plurality of antenna devices, receives channel information indicating channel quality between the terminal apparatus 6 and its own apparatus from the terminal apparatus 6, and outputs the received channel information to the communication quality estimation section 14. In addition, the wireless transmission/reception section 12 calculates a Doppler frequency in a subband (carrier frequency) generated by the movement of each terminal apparatus 6, which performs wireless communication, and outputs the calculated Doppler frequency to the Communication quality estimation section 14.

The radio scheduler 13 performs allocation of RBs to be used by the wireless transmission/reception section 12 to wirelessly communicate with the terminal apparatus 6 and radio scheduling for selecting a combination of a modulation scheme and a coding rate (a modulation and coding scheme (MCS)) on the basis of an SINR calculated by the communication quality estimation section 14, outputs results of the allocation and radio scheduling to the wireless transmission/reception section 12, and causes the wireless transmission/reception section 12 to perform wireless communication based on the above-described information.

The communication quality estimation section 14 calculates an SINR to be used by the radio scheduler 13 for the radio scheduling on the basis of channel information received by the wireless transmission/reception section 12 from the terminal apparatus 6 located within the communication area 1A of its own apparatus.

In addition, the communication quality estimation section 14 has a channel information acquisition section 141, a CQI-SINR conversion section 142, a selection section 143, a smoothing calculation section 144, a smoothed SINR storage section 145, and an SINR output section 146.

Channel information transmitted from the terminal apparatus 6 is input from the wireless transmission/reception section 12 to the channel information acquisition section 141. The CQI-SINR conversion section 142 has a conversion table 142A in which a CQI is associated with an SINR. The CQI-SINR conversion section 142 reads an SINR value indicating channel quality as an SINR value corresponding to a CQI included in channel information input to the channel information acquisition section 141 from the conversion table 142A, and converts the CQI into an SINR value γ_{received}(u, r, c, i, x).

Here, “u” (=1, 2, . . . , M) indicates a terminal ID, “r” indicates an RI, “c” indicates a code word ID, “i” indicates a subframe ID for uniquely identifying a subframe, and “x” indicates a frequency band (a system frequency band or any subband) in which an SINR value becomes a target. For example, a value incremented by 1 according to time-series is allocated as the subframe ID.

The selection section 143 selects any one of an SINR value γ_{received}(u, r, c, i, x) into which the conversion has been performed by the CQI-SINR conversion section 142 and an SINR value γ_{smoothing}(u, r, c, i−1, x) stored in the smoothed SINR storage section 145 as an instantaneous SINR value γ(u, r, c, i, x) according to a combination of a terminal ID, an RI, a code word ID, and band information included in the channel information input to the channel information acquisition section 141.

The smoothing calculation section 144 calculates a smoothed SINR value γ_{smoothing}(u, r, c, i, x) corresponding to each combination of a terminal ID, an RI, a code word ID, and band information using a Doppler frequency of each terminal apparatus 6 input from the wireless transmission/reception section 12, the instantaneous SINR value γ(u, r, c, i, x) selected by the selection section 143, and the SINR value γ_{smoothing} (u, r, c, I−1, x) stored in the smoothed SINR storage section 145.

In addition, the smoothing calculation section 144 updates the SINR value γ_{smoothing} by overwriting the SINR value γ_{smoothing} (u, r, c, i−1, x) stored in the smoothed SINR storage section 145 with the SINR value γ_{smoothing} (u, r, c, i, x).

The smoothed SINR value γ_{smoothing}(u, r, c, i, x) corresponding to each combination of a terminal ID, an RI, a code word ID, and band information is stored in the smoothed SINR storage section 145.

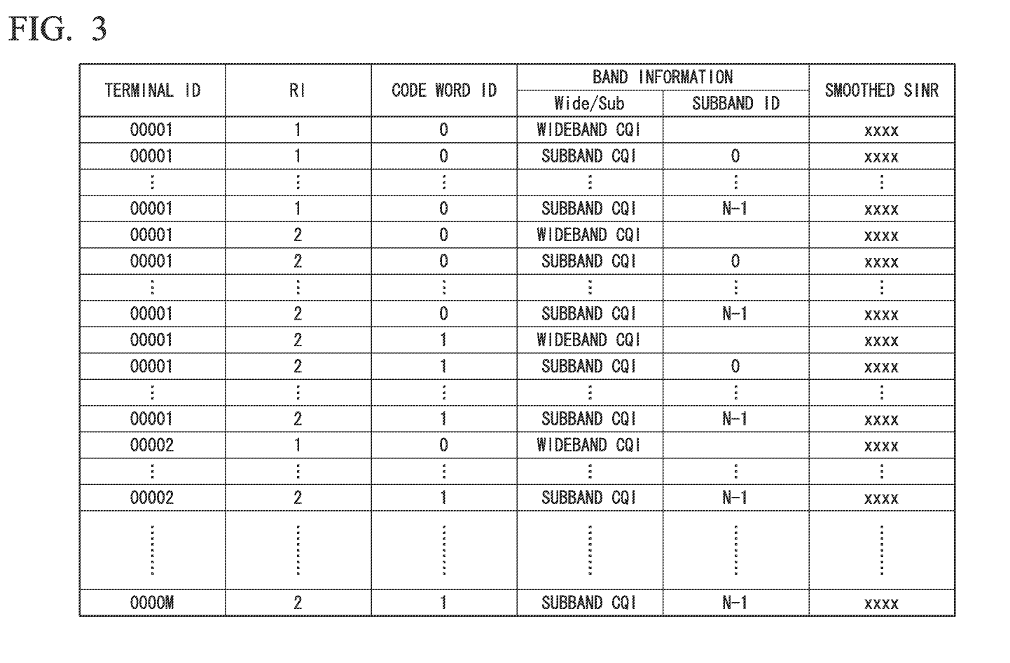

FIG. 3 is a diagram showing an example of information stored in the SINR storage section 145 according to this embodiment. In addition, the same drawing shows an example in which SINRs smoothed for M terminal apparatuses 6 are stored. In the smoothed SINR storage section 145, as shown in the same drawing, a smoothed SINR is stored for each combination of terminal IDs from “00001” to “0000M,” RIs of “1” and “2,” code word IDs of “0” and “1,” and band information of a “wideband CQI” (system frequency band) and a “subband CQI” (for each subband).

Returning to FIG. 2, the SINR output section 146 receives information indicating a combination of a terminal ID, an RI, a code word ID, and band information from the radio scheduler 13, reads a smoothed SINR value γ_{smoothing}(u, r, c, i, x) corresponding to the combination from the smoothed SINR storage section 145, and outputs the read SINR to the radio scheduler 13. That is, the SINR output section 146 reads an SINR value γ_{smoothing} corresponding to the terminal apparatus 6 serving as a target of radio scheduling by the radio scheduler 13 from the smoothed SINR storage section 145, and outputs the read SINR value to the radio scheduler 13.

The smoothing of an SINR value to be performed in the communication quality estimation section 14 will be described next.

The communication quality estimation section 14 sequentially smoothes an SINR value corresponding to each combination of a terminal ID, an RI, a code word ID, and band information for every subframe. Specifically, the communication quality estimation section 14 smoothes the SINR value by the following process.

The selection section 143 sequentially reads an SINR value γ_{smoothing}(u, r, c, i−1, x) corresponding to each combination of a terminal ID, an RI, a code word ID, and band information from the smoothed SINR storage section 145.

The selection section 143 determines whether or not the combination of the terminal ID, the RI, the code word ID, and the band information of the read SINR value γ_{smoothing}(u, r, c, i−1, x) is consistent with a combination of a terminal ID, an RI, a code word ID, and band information included in channel information input to the channel information acquisition section 141.

The selection section 143 outputs the SINR value γ_{received}(u, r, c, i, x) into which the conversion has been performed by the CQI-SINR conversion section 142 as the instantaneous SINR value γ(u, r, c, i, x) if the combinations are consistent, and outputs the read SINR value γ_{smoothing}(u, r, c, i−1, x) as the instantaneous SINR value γ(u, r, c, i, x) if the combinations are not consistent.

That is, if a CQI consistent with a combination of parameters of a terminal ID, an RI, a code word ID, and band information has been received in a current subframe, an SINR value γ_{received}(u, r, c, i, x) corresponding to the CQI is set and output as the instantaneous SINR value γ(u, r, c, i, x). If the consistent CQI has not been received, an SINR value γ_{smoothing}(u, r, c, i, x) smoothed one frame ago is set and output as the instantaneous SINR value γ(u, r, c, i, x).

The process of the selection section 143 is expressed as the following Equation (1).

$$γ ( u , r , c , t , x ) = \{ \begin{matrix}{γ}_{recieved} ( u , r , c , i , x ) if C Q I consistent \\ with combination of parameters \\ has been received in subframe i \\ {γ}_{smoothing} ( u , r , c , i - 1 , x ) otherwise\end{matrix} \qquad ( 1 )$$

The smoothing calculation section 144 reads an SINR value γ_{smoothing}(u, r, c, i−1, x) consistent with a combination of a terminal ID, an RI, a code word ID, and band information of the instantaneous SINR value γ(u, r, c, i, x) input from the selection section 143 from the smoothed SINR storage section 145.

The smoothing calculation section 144 performs smoothing expressed by the following Equation (2) using the read SINR value γ_{smoothing}(u, r, c, i−1, x) and the input instantaneous SINR value γ(u, r, c, i, x).

γ_{smoothing}(u,r,c,i,x)=(1−α(fᵤ))γ_{smoothing},(u,r,c,i−1,x)+α(fᵤ)γ(u,r,c,i,x) (2)

Here, α(fᵤ) is a function of giving a forgetting factor corresponding to a Doppler frequency fᵤ, (u=1, 2, . . . , M) of the terminal apparatus 6 (u), and is expressed by the following Equation (3).

$$α ( {f}_{u} ) = \{ \begin{matrix}{β}_{0} & {f}_{u} \leq {th}_{f} \\ {β}_{1} & {f}_{u} > {th}_{f}\end{matrix} , \\ 0 \leq {β}_{0} , {β}_{1} \leq 1 \qquad ( 3 )$$

In Equation (3), forgetting factors β₀ and β₁ and a threshold th_{f} are values predetermined using simulations, actual measured values, or the like.

The smoothing calculation section 144 performs smoothing expressed by Equation (2) for each combination of a terminal ID, an RI, a code word ID, and band information, and updates an SINR value γ_{smoothing} corresponding to each combination of parameters by storing a calculated SINR value γ_{smoothing}(u, r, c, i, x) in the smoothed SINR storage section 145.

As described above, the communication quality estimation section 14 acquires channel quality information received by the channel information acquisition section 141 from each terminal apparatus 6, smoothes an SINR value γ_{received} calculated by the smoothing calculation section 144 from the channel quality information, and stores the smoothed SINR value γ_{smoothing} in the smoothed SINR storage section 145 in association with each combination of a terminal ID, an RI, a code word ID, and band information of the terminal apparatus 6. The radio scheduler 13 uses the SINR value γ_{smoothing} smoothed using the channel quality information so far for radio scheduling.

Thereby, it is possible to reduce a difference between an SINR value used for radio scheduling and an SINR value during communication based on a result of the radio scheduling even when channel quality between the base station apparatus 1 and the terminal apparatus 6 has been temporarily varied in units of subframes. For example, it is possible to reduce a difference between channel quality used for radio scheduling and channel quality during communication based on a result of the radio scheduling using a smoothed SINR value in radio scheduling without using an SINR value corresponding to a temporarily degraded or improved CQI (channel quality) if a transmission path environment has been temporarily greatly varied by an obstacle or reflecting object moving between the base station apparatus 1 and the terminal apparatus 6.

As a result, because it is possible to perform radio scheduling for reducing an influence caused by temporary variation of channel quality occurring in units of subframes, the accuracy of the radio scheduling can be improved and the reliability of a CQI or PMI can be improved. In addition, the accuracy of an MCS selected by the radio scheduler 13 can be improved and the occurrence of retransmission can be suppressed by improving the reliability of a CQI or PMI. It is possible to improve frequency use efficiency because a radio resource is effectively used by reducing the number of RBs allocated for retransmission.

In addition, because a smoothed SINR value γ_{smoothing} is stored in the SINR storage section 145 for each combination of a terminal ID, an RI, a code word ID, and band information, the radio scheduler 13 can perform scheduling based on an SINR value γ_{smoothing} corresponding to each combination of the number of MIMO signal sequences and a subband (frequency band), and improve a transmission capacity by use of MIMO.

In this embodiment, smoothing to be performed by the smoothing calculation section 144 is not limited to the smoothing expressed by Equation (1), and smoothing by linear addition expressed by the following Equation (4) may be applied.

$${γ}_{smoothing} ( u , r , c , i , x ) = {\sum }_{l = 0}^{p - 1} α ( {f}_{u} , l ) γ ( u , r , c , i - l , x ) \qquad ( 4 )$$

Here, in Equation (4), “p” is a value indicating a predetermined elapsed time and SINR values from a previous (p−1) subframe to a current subframe are smoothed.

In addition, α(fᵤ, l) is a function of giving a forgetting factor corresponding to a Doppler frequency fᵤ of the terminal apparatus 6 (u) and an elapsed time l as in Equation (3). That is, the smoothing calculation section 144 smoothes an SINR value by weighted addition in which a weight decreases with a passage of time.

In addition, although a configuration in which a comparison between one threshold th_{f} and the Doppler frequency fᵤ of the terminal apparatus 6 in a function expressed by Equation (3) is performed and any one of the two forgetting factors β₀ and β₁ is used has been described in this embodiment, the present invention is not limited thereto. Any one of n forgetting factors may be selected by predetermining (n−1) thresholds and the n forgetting factors and comparing the Doppler frequency fᵤ of the terminal apparatus 6 to the (n−1) thresholds.

In addition, in this embodiment, an initial value γ_{smoothing}(u, r, c, 0, x) of an SINR value γ_{smoothing}(u, r, c, i, x) stored in the smoothed SINR storage section 145 may be 0 [dB] or a predetermined value.

### Second Embodiment

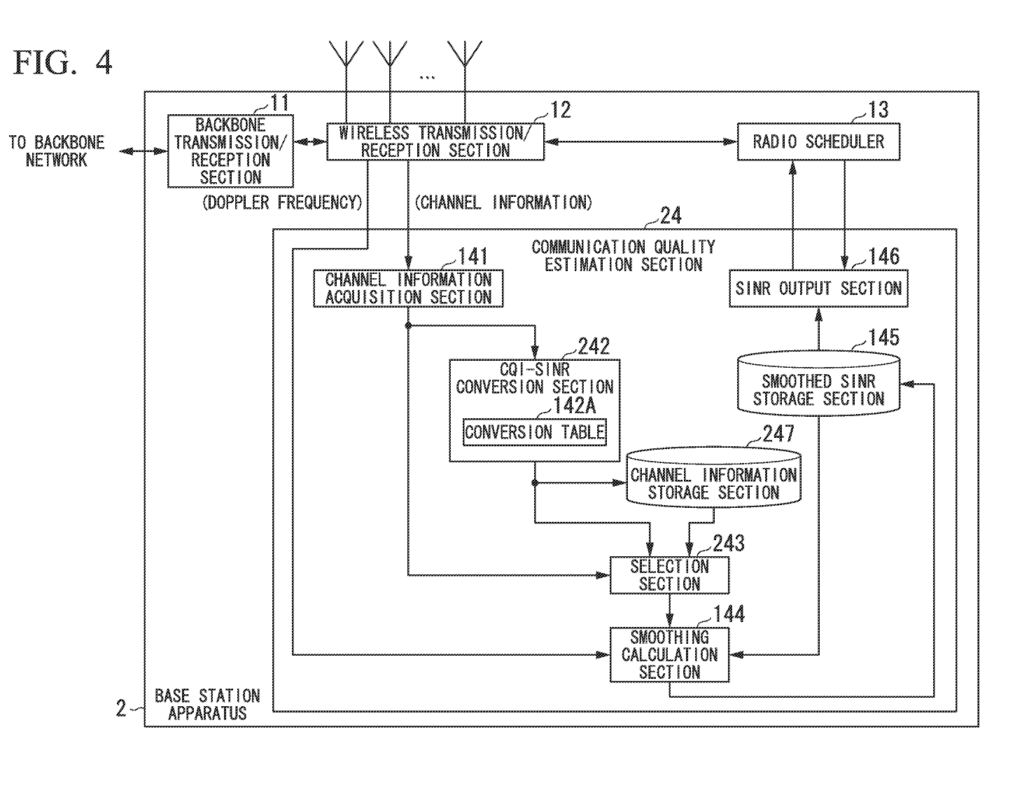

FIG. 4 is a schematic block diagram showing a configuration of a base station apparatus 2 according to the second embodiment. As shown in the same drawing, the base station apparatus 2 is different from the base station apparatus 1 (FIG. 2) of the first embodiment in that a communication quality estimation section 24 has a channel information storage section 247 and the communication quality estimation section 24 has a CQI-SINR conversion section 242 and a selection section 243 in place of the CQI-SINR conversion section 142 and the selection section 143, respectively. The same configurations as those of the base station apparatus 1 are denoted by the same reference numerals in the base station apparatus 2, and description thereof is omitted.

Like the CQI-SINR conversion section 142, the CQI-SINR conversion section 242 has a conversion table 142A in which a CQI is associated with an SINR, and converts a CQI into an SINR value γ_{received}(u, r, c, x) by reading an SINR value corresponding to a CQI included in channel information input to the channel information acquisition section 141 from the conversion table 142A. In addition, the CQI-SINR conversion section 242 associates and stores a current subframe ID(i) and an SINR value γ_{received}(u, r, c, i, x) in a channel information storage section 247.

Each SINR value γ_{received}(u, has r, c, k, x) into which a conversion h been performed by the CQI-SINR conversion section 242 associated with a subframe ID(k) (k=0, 1, 2, . . . , i) is stored in the channel information storage section 247.

Like the selection section 143 of the first embodiment, the selection section 243 selects any one of the SINR value γ_{received}(u, r, c, i, x) into which the conversion has been performed by the CQI-SINR conversion section 242 and an SINR value γ_{received}(u, r, c, j, x) stored in the channel information storage section 247 as an instantaneous SINR value γ(u, r, c, i, x) according to a combination of a terminal ID, an RI, a code word ID, and band information included in channel information input to the channel information acquisition section 141, and outputs the selected SINR value to the smoothing calculation section 144. Here, the SINR value γ_{received}(u, r, c, j, x) is an SINR value γ_{received corresponding to a last received CQI among SINR values γ}_{received} corresponding to previously received CQIs. That is, j is a largest value among values satisfying j<i. Specifically, a process of the selection section 243 is expressed as the following Equation (5).

$$γ ( u , r , c , i , x ) = \{ \begin{matrix}{γ}_{received} ( u , r , c , i , x ) \text{if} CQI \text{consistent} \\ \text{with combination of parameters} \\ \text{has been received in subframe} t \\ {γ}_{received} ( u , r , c , i , x ) \text{otherwise}\end{matrix} \qquad ( 5 )$$

As described above, in the communication quality estimation section 24 of this embodiment, the selection section 243 selects Equation (5) in place of Equation (1). That is, if a CQI consistent with a combination of parameters of a terminal ID, an RI, a code word ID, and band information has not been received in a calculation (update) of the SINR value γ_{smoothing}(u, r, c, i, x), an SINR value γ_{received}(u, r, c, j, x), which is consistent with the parameter combination and corresponds to the last received CQI, is used as the instantaneous SINR value γ(u, r, c, i, x).

In the first embodiment, because an SINR value γ_{smoothing}(u, r, c, i−1, x) is smoothed as the instantaneous SINR value γ(u, r, c, i, x) if a CQI consistent with a combination of parameters of a terminal ID, an RI, a code word ID, and band information has not been received, γ_{smoothing}(u, r, c, i, x)=γ_{smoothing}(u, r, c, i−1, x) in Equation (2). This means that the smoothed SINR value γ_{smoothing}(u, r, c, i, x) is continuously retained when the CQI consistent with the parameter combination is not received.

In this embodiment, Equation (5) is used to gradually reduce an influence of an old SINR value γ_{received} on the SINR value γ_{smoothing} when the CQI consistent with the parameter combination is not received.

Thereby, it is possible to suppress a gap between a smoothed SINR value γ_{smoothing} and channel quality varying with time from being increased even in a period in which the CQI consistent with the parameter combination is not received by gradually reducing the influence of the old SINR value γ_{received} on the SINR value γ_{smoothing}.

Although a configuration in which the selection section 243 makes a selection expressed by Equation (5) has been described in this embodiment, the present invention is not limited thereto. Another selection may be made so that an influence of the SINR value γ_{received} after the passage of time from the CQI reception on the smoothed SINR value γ_{smoothing} is gradually reduced. For example, the selection section 243 may make a selection expressed by the following Equation (6) in place of Equation (5).

$$γ ( u , r , c , i , x ) = \{ \begin{matrix}{γ}_{received} ( u , r , c , i , x ) if CQI consistent with \\ combination of parameters has been received in subframe t \\ {γ}_{received} ( u , r , c , j , x ) if CQI inconsistent with \\ combination of parameters has been received in \\ subframe t and j satisfying ( t - j ) \leq t exists \\ \frac{1}{\text{?}} ( {γ}_{default} - ( 1 - α f ( f \text{?} ) {γ}_{smoothing} ( u , r , c , b - 1 , x ) ) otherwise\end{matrix} \\ \text{?} \text{indicates text missing or illegible when filed} \qquad ( 6 )$$

When a CQI consistent with a combination of parameters is not received according to the selection expressed by Equation (5), the influence of the old SINR value γ_{received} on the SINR value γ_{smoothing} is gradually reduced. However, a state in which an influence on the SINR value γ_{smoothing} of the received CQI is gradually excluded is reached before a subframe j, and finally it converges to an SINR value γ_{received} corresponding to a CQI received in the subframe j.

The selection section 243 makes the selection expressed by Equation (6), so that the SINR value γ_{smoothing} is initialized when the CQI received in the subframe j is old. In the selection by Equation (6), SINR Value γ_{smoothing}(u, r, c, i, x)=Initial Value γ_{default} if an elapsed time from the subframe j in which the last CQI is received among subframes before the subframe i exceeds a time t. A predetermined value may be used as the initial value γ_{default} on the basis of simulations or actually measured values.

Thereby, an SINR value γ_{smoothing} is calculated without using a CQI when a predetermined t has elapsed after the reception, thereby suppressing a gap between an SINR value γ_{smoothing} to be used for radio scheduling and actual channel quality from being increased by receiving an influence of an old CQI.

### Third Embodiment

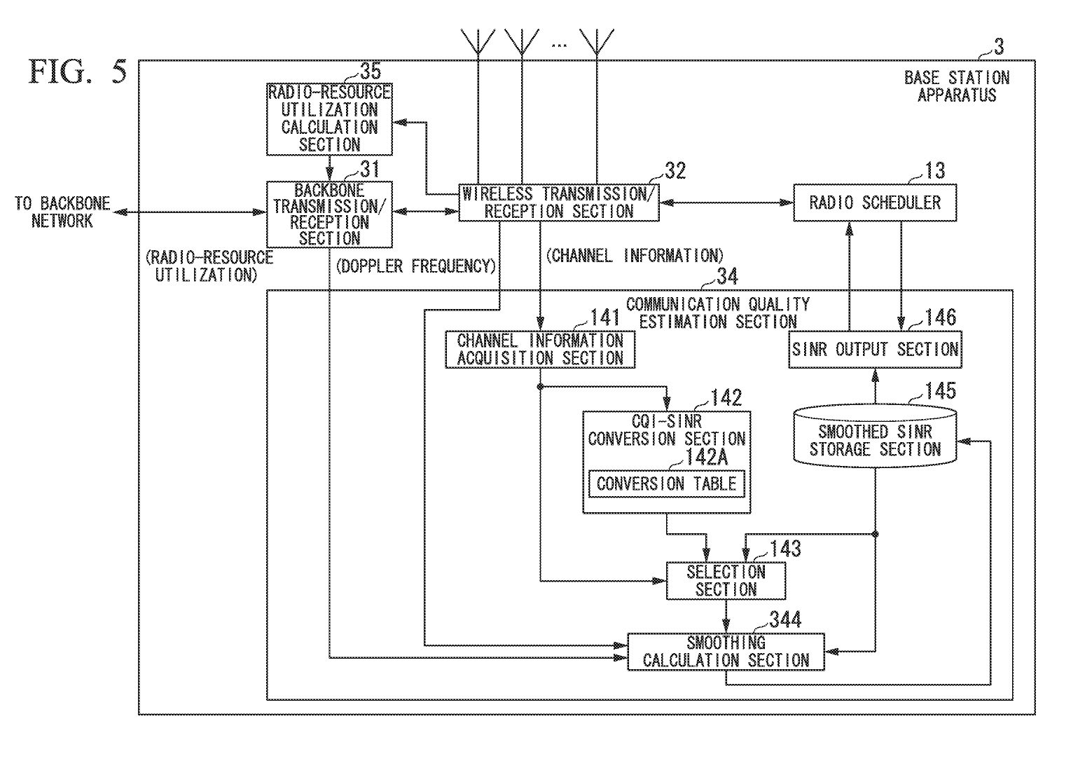

FIG. 5 is a schematic block diagram showing a configuration of a base station apparatus 3 according to the third embodiment. As shown in the same drawing, the base station apparatus 3 is different from the base station apparatus 1 (FIG. 2) of the first embodiment in that a backbone transmission/reception section 31 is provided in place of the backbone transmission/reception section 11, a wireless transmission/reception section 32 is provided in place of the wireless transmission/reception section 12, a communication quality estimation section 34 has a communication quality estimation section 344 in place of the smoothing calculation section 144, and a radio-resource utilization calculation section 35 is provided. The same configurations as those of the base station apparatus 1 are denoted by the same reference numerals in the base station apparatus 3, and description thereof is omitted.

Like the backbone transmission/reception section 11 of the first embodiment, the backbone transmission/reception section 31 receives information addressed to the terminal apparatus 6 in which wireless communication with another base station apparatus 3 is ongoing from the wireless transmission/reception section 32, and transmits information input to the base station apparatus 3 in which wireless communication with the terminal apparatus 6 is ongoing. In addition, like the backbone transmission/reception section 11, the backbone transmission/reception section 31 receives information addressed to the terminal apparatus 6 in which wireless communication with its own apparatus is ongoing from another base station apparatus 3 and outputs the received information to the wireless transmission/reception section 32.

Further, the backbone transmission/reception section 31 transmits utilization information indicating radio-resource utilization calculated by the radio-resource utilization calculation section 35 to a neighboring base station apparatus 3. In addition, the backbone transmission/reception section 31 outputs utilization information received from the neighboring base station apparatus 3 to the communication quality estimation section 34. For example, in the LTE, there is a format of a message defined as load information on the backbone network 7 referred to as an X2 interface. It is possible to transmit the utilization information to the neighboring base station apparatus 3 by performing a broadcasting operation using the load information message.

When the load information on the X2 interface of the LTE is used, it is necessary to quantize the utilization information to one or two bits for a comparison with a threshold because one- or two-bit information can be transmitted for each radio resource unit on the above-described frequency axis.

Like the wireless transmission/reception section 12 of the first embodiment, the wireless transmission/reception section 32 wirelessly communicates with the terminal apparatus 6 located within the communication area 1A of its own apparatus via a plurality of antenna devices, receives channel information indicating channel quality between the terminal apparatus 6 and its own apparatus from the terminal apparatus 6, and outputs the received channel information to the communication quality estimation section 14. Further, the wireless transmission/reception section 32 outputs information indicating the presence/absence of radio resource use to the radio-resource utilization calculation section 35.

The radio-resource utilization calculation section 35 calculates radio-resource utilization in its own apparatus using information input from the wireless transmission/reception section 32.

Specifically, the radio-resource utilization calculation section 35 divides radio resources on the frequency axis into certain units, and sequentially calculates radio-resource utilization over a time axis and the frequency axis for each same unit with a passage of time. When an index for identifying a minimum unit of the radio resources is j (j=0, 1, 2, . . . , J−1) in a unit b of the radio resources divided on the frequency axis, a current time is t₀, and a utilization calculation period of the radio resources is T, radio-resource utilization(s,b) in the base station apparatus 3 (s) is calculated using the following Equation (7).

$$utilization ( s , b ) = \frac{( {\sum }_{t = {t}_{0}}^{{t}_{0} - T + 1} {\sum }_{j = 0}^{J - 1} g ( s , b , t , j ) )}{( T \times J )} \\ g ( s , b , t , j ) = \{ \begin{matrix}1 when radio resource j of time t is used \\ in radio resource unit \text{:} b of base station apparatus s \\ 0 otherwise\end{matrix} \qquad ( 7 )$$

The smoothing calculation section 344 calculates an SINR value γ_{smoothing}(u, r, c, I, x) corresponding to each combination of a terminal ID, an RI, a code word ID, and band information using an instantaneous SINR value γ(u, r, c, i, x) selected by the selection section 143, an SINR value γ_{smoothing}(u, r, c, i−1, x) stored in the smoothed SINR storage section 145, and utilization information input from the backbone transmission/reception section 31.

In addition, like the smoothing calculation section 144 of the first embodiment, the smoothing calculation section 344 updates the SINR value γ_{smoothing} by overwriting the SINR value γ_{smoothing} (u, r, c, i−1, x) stored in the smoothed SINR storage section 145 with the SINR value γ_{smoothing} (u, r, c, i, x).

Here, the smoothing calculation section 344 of this embodiment is different from the smoothing calculation section 144 of the first embodiment in that an SINR value is smoothed using utilization information indicating radio-resource utilization in the neighboring base station apparatus 3 in place of the Doppler frequency. The smoothing calculation section 344 gathers utilization information input from the backbone transmission/reception section 31, and uses the gathered utilization information for a calculation of the SINR value γ_{smoothing} (u, r, c, i, x). Through this gathering, different utilizations received from a plurality of neighboring base station apparatuses 3 for each radio-resource unit on the frequency axis may be used and an average value or a weighted average value of utilization of the neighboring base station apparatus 3 may be used.

If the weighted average value is used, a weighting operation may be performed using the received electric field intensity of a pilot signal from the neighboring base station apparatus 3 measured by the terminal apparatus 6, which wirelessly communicates with its own apparatus. For example, a weight for utilization of the base station apparatus 3 having high received electric field intensity is increased.

When radio-resource utilization of the neighboring base station apparatus 3 is merely averaged, average utilization h(s₀) of the neighboring base station apparatuses 3 (s₁, s₂, . . . , s₅) is calculated in its own apparatus s₀ using the following Equation (8). When the load information on the X2 interface of the LTE is used, the quantized one- or two-bit information is converted into a real number, and then the average utilization h(s₀) is calculated using the following Equation (8).

$$h ( {s}_{0} ) = ( {\sum }_{s = {s}_{1}}^{{s}_{S}} g ( s , b , t , j ) ) / S \qquad ( 8 )$$

The smoothing calculation section 344 selects a forgetting factor α(s₀) of the SINR value corresponding to a previously received CQI using the calculated average utilization h(s₀). That is, the smoothing calculation section 344 selects the forgetting factor α(s₀) using the following Equation (9) in place of Equation (3) in the smoothing calculation section 144.

$$α ( {s}_{0} ) = \{ \begin{matrix}{β}_{0} & {th}_{0} \leq h ( {s}_{0} ) \leq {th}_{1} \\ {β}_{1} & otherwise ,\end{matrix} \\ 0 \leq {β}_{0} < {β}_{1} \leq 1 \qquad ( 9 )$$

Here, thresholds th₀ and th₁ in Equation (9) are predetermined values based on simulations or actually measured values.

In addition, the smoothing calculation section 344 calculates the SINR value γ_{smoothing} (u, r, c, i, x) using the following Equation (10).

γ_{smoothing}(u,r,c,i,x)=(1−α(s₀))γ_{smoothing}(u,r,c,i−1,x)+α(s₀)γ(u,r,c,i,x) (10)

In general, if the radio-resource utilization in the neighboring base station apparatus 3 is very low or high, a difference between interference received from the neighboring base station apparatus 3 when a CQI is determined and interference received from the neighboring base station apparatus 3 when transmission is performed using a result of radio scheduling is more likely to be reduced. On the other hand, if the radio resource utilization in the neighboring base station apparatus 3 is about 50%, a difference between interference received from the neighboring base station apparatus 3 when a CQI is determined and interference received from the neighboring base station apparatus 3 when transmission is performed using a result of radio scheduling is more likely to be reduced.

The communication quality estimation section 34 of this embodiment performs a process based on a correspondence relationship between the radio-resource utilization and the interference in the neighboring base station apparatus 3 as described above. Specifically, if the average utilization h(s₀) of its own apparatus is not in a range defined by the thresholds th₀ and th₁ using the two thresholds th₀ and th₁, the smoothing calculation section 344 increases a weight for the instantaneous SINR value γ output by the selection section 143. Otherwise, the smoothing calculation section 344 increases a weight for the smoothed SINR value γ_{smoothing}. The range defined by the thresholds th₀ and th₁ is defined to include “0.5.” For example, th₀ is set as “0.25” and th₁ is set as “0.75.”

Thereby, it is possible to calculate the smoothed SINR value γ_{smoothing} considering a possibility that interference received from the neighboring base station apparatus 3 is varied using the radio-resource utilization in the neighboring base station apparatus 3. As a result, because it is possible to perform radio scheduling for reducing an influence caused by temporary variation of channel quality occurring in units of subframes, the accuracy of radio scheduling can be improved and the reliability of a CQI or PMI can be improved. In addition, the accuracy of an MCS selected by the radio scheduler 13 can be improved and the occurrence of retransmission can be suppressed by improving the reliability of a CQI or PMI. It is possible to improve frequency use efficiency because a radio resource is effectively used by reducing the number of RBs allocated for retransmission.

Although a configuration in which a forgetting factor α is selected using the average utilization h(s₀) of each base station apparatus 3 in place of the Doppler frequency fᵤ of each terminal apparatus 6 has been described in this embodiment, the present invention is not limited thereto. The forgetting factor α may be selected using the Doppler frequency fᵤ and the average utilization h(s₀). For example, the smoothing calculation section 344 may calculate the smoothed SINR value γ_{smoothing} by selecting any one of forgetting factors β₀, β₁, and β₂ as expressed by the following Equation (11) in place of Equation (9).

$$α ( {s}_{0} , {f}_{u} ) = \{ \begin{matrix}{β}_{0} & ( {th}_{0} \leq h ( {s}_{0} ) \leq {th}_{1} ) ⋀ ( {f}_{u} \leq {th}_{f} ) \\ {β}_{1} & ( {th}_{0} \leq h ( {s}_{0} ) \leq {th}_{1} ) ⋀ ( {f}_{u} > {th}_{f} ) \\ {β}_{2} & otherwise ,\end{matrix} \\ 0 \leq {β}_{0} < {β}_{1} < {β}_{2} \leq 1 \qquad ( 11 )$$

In addition, when each terminal apparatus 6 performs wireless communication using closed-loop MIMO, a state of interference received from a neighboring communication area is also significantly varied when a PMI of the terminal apparatus 6 in which wireless communication using the same frequency is ongoing is varied in the neighboring communication area. The variation of the interference state as described above also occurs when radio-resource utilization of the neighboring base station apparatus 3 is high. The forgetting factor may be selected using a ratio of terminal apparatuses 6 in which wireless communication using closed-loop MIMO is ongoing in place of the radio-resource utilization of the neighboring base station apparatus 3.

In this case, each base station apparatus 3 may include a ratio calculation section, which calculates a ratio of terminal apparatuses 6 performing wireless communication with the base station apparatus 3 using closed-loop MIMO is ongoing among terminal apparatuses 6, in place of the radio-resource utilization calculation section 35 and transmits a ratio calculated via the backbone network 7 to the neighboring base station apparatus 3. In addition, the smoothing calculation section 344 calculates a statistical value (an average, a weighted average, a medium value, or the like) k(s₀) of a ratio of terminal apparatuses 6 received from the neighboring base station apparatus 3, and selects a forgetting factor using the calculated statistical value k(s₀). For example, as shown in the following Equation (12), the forgetting factor α(s₀) is determined. That is, the forgetting factor α(s₀) is determined by determining whether or not the ratio of terminal apparatuses 6 in which wireless communication using closed-loop MIMO is ongoing is equal to or greater than a predetermined threshold th₂.

$$α ( {s}_{0} ) = \{ \begin{matrix}{β}_{0} & k ( {s}_{0} ) \geq {th}_{2} \\ {β}_{1} & otherwise ,\end{matrix} \\ 0 \leq {β}_{0} < {β}_{1} \leq 1 \qquad ( 12 )$$

Thereby, it is possible to calculate the smoothed SINR value γ_{smoothing} considering the variation of interference by a change of a PMI of the terminal apparatus 6 in which wireless communication using closed-loop MIMO is ongoing in the communication area of the neighboring base station apparatus 3.

In addition, the communication quality estimation section 34 may select the forgetting factor by combining radio-resource utilization of the above-described neighboring base station apparatus 3, a Doppler frequency of each terminal apparatus 6, and a ratio of terminal apparatuses 6, which wirelessly communicate with the neighboring base station apparatus 3 using the closed-loop MIMO. For example, the smoothing calculation section 344 may select the forgetting factor expressed by the following Equation (13).

$$α ( {s}_{0} , {f}_{u} ) = \{ \begin{matrix}{β}_{0} & ( ( {th}_{0} \leq h ( {s}_{0} ) \leq {th}_{1} ) ⋁ ( k ( {s}_{0} ) \geq {th}_{2} ) ) ⋀ ( {f}_{u} \leq {th}_{f} ) \\ {β}_{1} & ( ( {th}_{0} \leq h ( {s}_{0} ) \leq {th}_{1} ) ⋁ ( k ( {s}_{0} ) \geq {th}_{2} ) ) ⋀ ( {f}_{u} > {th}_{f} ) \\ {β}_{2} & otherwise\end{matrix} \\ 0 \leq {β}_{0} < {β}_{1} < {β}_{2} \leq 1 \qquad ( 13 )$$

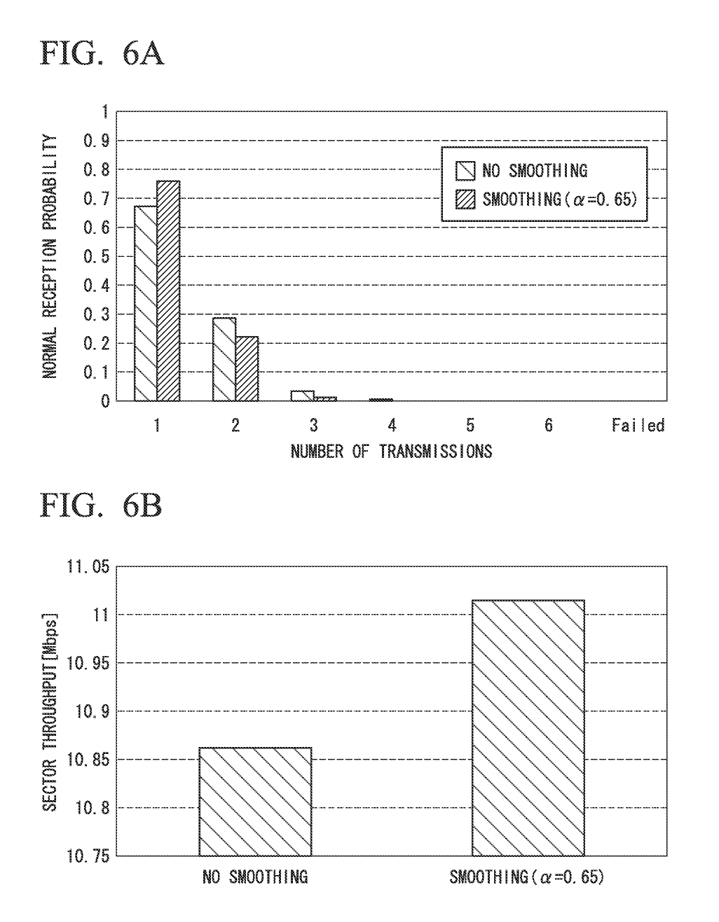

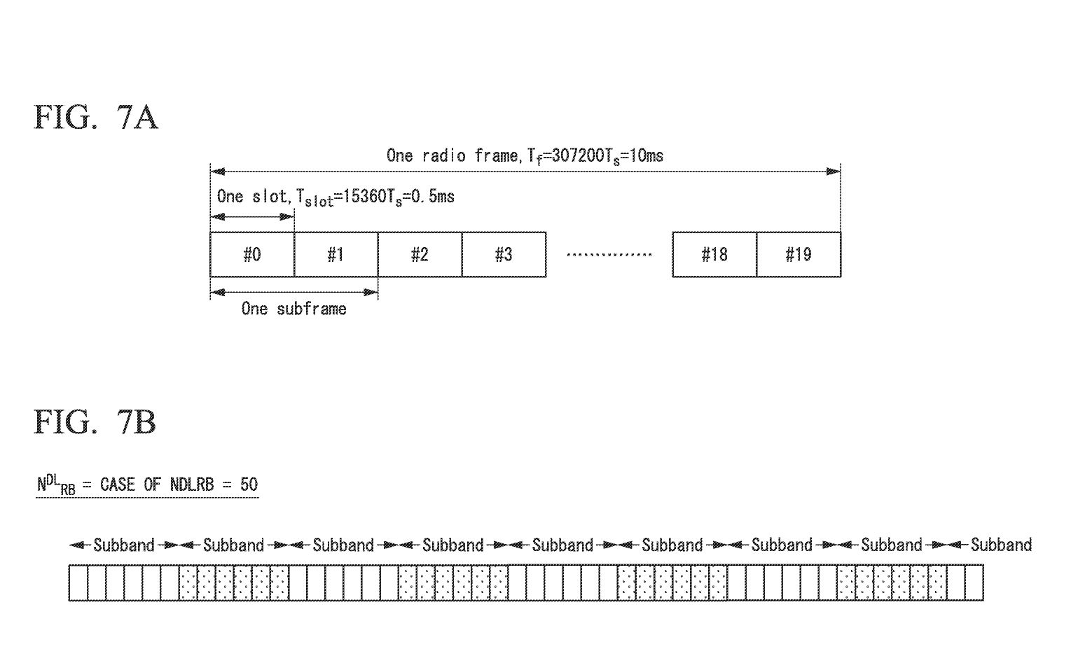

FIGS. 6A and 6B are diagrams showing the advantageous effects by the base station apparatus 1 according to the first embodiment. In addition, the same drawing is a diagram showing a result of computer simulations. FIG. 6A is a graph showing a packet reception success rate when information is transmitted from the base station apparatus 1 to the terminal apparatus 6. The horizontal axis represents the number of transmissions, and the vertical axis represents a reception success rate. As shown in the same drawing, a probability that a packet can be accurately received when first transmission ends is improved by about 10% when radio scheduling is performed using the smoothed SINR value γ_{smoothing} (smoothing (α=0.65)) as compared to when radio scheduling is performed on the basis of a CQI received four subframes ago (no smoothing). As described above, it is possible to suppress an influence of temporarily varied channel quality by performing radio scheduling using the smoothed SINR value γ_{smoothing} and improve the accuracy of subcarrier selection or MCS selection in radio scheduling.

As a result, it is possible to reduce the number of radio resources to be used when a packet is transmitted and improve frequency use efficiency.

FIG. 6B is a diagram showing a sector throughput [Mbps] when information is transmitted from the base station apparatus 1 to the terminal apparatus 6. As shown in the same drawing, the sector throughput is improved by about 1.4%.

If there is a terminal apparatus 6 in which wireless communication using MIMO is not performed in each embodiment described above, a process may be performed by setting a possible value of the RI to only “1,” and setting a possible value of a code word ID to only “0.” In this case, a smoothed SINR corresponding to a wideband CQI and a smoothed SINR corresponding to each subband CQI for the terminal apparatus 6 in which MIMO does not operate are stored in the smoothed SINR storage section 145.

In addition, although the case where two values for the RI and the code word ID are possible has been described in each embodiment described above, the present invention is not limited thereto. Three or more values may be possible.

In addition, although a configuration in which a smoothed SINR value γ_{smoothing} (smoothed channel quality information) for each combination of a terminal ID, an RI, a code word ID, and band information is stored in the smoothed SINR storage section 145 has been described in each embodiment described above, the present invention is not limited thereto. The SINR value γ_{smoothing} for each terminal ID may be stored in the smoothed SINR storage section 145, and the SINR value γ_{smoothing} for a combination of a terminal ID and band information may be stored in the smoothed SINR storage section 145.

A process of calculating and updating an SINR value γ_{smoothing} may be executed by recording a program for implementing the function of the communication quality estimation section 14 (24 or 34) described above on a computer-readable recording medium and causing a computer system to read and execute the program recorded on the recording medium. The “computer system” includes an operating system (OS), and hardware such as peripheral devices. The “computer system” also includes the World Wide Web (WWW) system including a homepage providing (or displaying) environment.

The “computer readable recording medium” is a portable medium such as a flexible disk, magneto-optical disc, read-only memory (ROM) and compact disc-ROM (CD-ROM), and a storage device, such as a hard disk, built in the computer system. Moreover, the “computer-readable recording medium” also includes a medium that retains a program for a constant time period, such as volatile memory (RAM) inside a computer system serving as a server or a client when the program has been transmitted through a network such as the Internet and a communication line such as a telephone line.

In addition, the above-described program may be transmitted from a computer system in which this program has been stored in a storage apparatus and the like to another computer via a transmission medium or by transmitted waves in the transmission media. Here, the “transmission medium” for transmitting a program refers to a medium that functions to transmit information as in a network (communication network) such as the Internet and the like and a communication link (communication line) such as a telephone line and the like. The above-described program may implement a part of the above-described function. The above-described program may be a differential file (differential program) capable of implementing the above-described function in combination with a program already recorded on the computer system

What is claimed is:

1. A communication quality estimation apparatus comprising:
a channel information acquisition section configured to receive channel quality information indicating channel quality in transmission paths between a plurality of terminal apparatuses and a base station apparatus from the plurality of terminal apparatuses for each subframe;
a smoothing calculation section configured to calculate smoothed channel quality information by smoothing the channel quality information received so far from the terminal apparatus for each terminal apparatus; and
a smoothed information storage section configured to store the smoothed channel quality information calculated by the smoothing calculation section in association with an ID of each of the plurality of terminal apparatuses.

2. The communication quality estimation apparatus as claimed in claim 1, wherein the terminal apparatus and the base station apparatus perform wireless communication using any one of a plurality of predetermined frequency bands,
the smoothing calculation section further calculates the smoothed channel quality information for each combination of the terminal apparatus and the frequency band, and
the smoothed information storage section stores the smoothed channel quality information in association with each combination of the terminal apparatus and the frequency band.

3. The communication quality estimation apparatus as claimed in claim 1, wherein the terminal apparatus and the base station apparatus perform wireless communication to which closed-loop MIMO is applied,
the smoothing calculation section further calculates the smoothed channel quality information for each combination of the number of signal sequences to be transmitted in parallel and IDs for identifying the signal sequences, and
the smoothed information storage section further stores the smoothed channel quality information in association with each combination of the number of signal sequences to be transmitted in parallel and the IDs for identifying the signal sequences.

4. The communication quality estimation apparatus as claimed in claim 1, wherein the smoothing calculation section performs an update process of multiplying each of channel quality information received in a current subframe and the smoothed channel quality information of a terminal apparatus corresponding to the channel quality information by a predetermined forgetting factor and setting a sum of multiplication results to new smoothed channel quality information for every subframe.

5. The communication quality estimation apparatus as claimed in claim 4, wherein, if no channel quality information is received in the current subframe, the smoothing calculation section performs an update process of multiplying each of last received channel quality information and the smoothed channel quality information of a terminal apparatus corresponding to the channel quality information by the forgetting factor and setting a sum of the multiplication results to new smoothed channel quality information for every subframe.

6. The communication quality estimation apparatus as claimed in claim 4, wherein, when a predetermined period has elapsed after last channel quality information has been received if no channel quality information is received in the current subframe, the smoothing calculation section performs an update process of multiplying each of a predetermined initial value and the smoothed channel quality information by the forgetting factor and setting a sum of the multiplication results to new smoothed channel quality information for every subframe.

7. The communication quality estimation apparatus as claimed in claim 1, wherein the smoothing calculation section selects any one of a plurality of predetermined forgetting factors on the basis of an amount of variation of a carrier frequency occurring due to movement of the terminal apparatus, and updates the smoothed channel quality information using the selected forgetting factor.

8. The communication quality estimation apparatus as claimed in claim 1, wherein the smoothing calculation section selects any one of a plurality of predetermined forgetting factors on the basis of radio-resource utilization in a base station apparatus neighboring the base station apparatus, and updates the smoothed channel quality information using the selected forgetting factor.

9. The communication quality estimation apparatus as claimed claim 1, wherein the smoothing calculation section selects any one of a plurality of predetermined forgetting factors on the basis of a ratio of terminal apparatuses that perform communication using closed-loop MIMO, among terminal apparatuses that communicate with a base station apparatus neighboring the base station apparatus, and updates the smoothed channel quality information using the selected forgetting factor.

10. A base station apparatus comprising:
a channel information acquisition section configured to receive channel quality information indicating channel quality in transmission paths between a plurality of terminal apparatuses and the base station apparatus from the plurality of terminal apparatuses for each subframe;
a smoothing calculation section configured to calculate smoothed channel quality information by smoothing the channel quality information received so far from the terminal apparatus for each terminal apparatus;
a smoothed information storage section configured to store the smoothed channel quality information calculated by the smoothing calculation section in association with an ID of each of the plurality of terminal apparatuses;
a radio scheduler configured to allocate radio resources to the plurality of terminal apparatuses using the smoothed channel quality information corresponding to each of the plurality of terminal apparatuses; and
a wireless transmission/reception section configured to communicate with the plurality of terminal apparatuses using the radio sources allocated by the radio scheduler to the plurality of terminal apparatuses.

11. A communication quality estimation method comprising:
receiving channel quality information indicating channel quality in transmission paths between a plurality of terminal apparatuses and a base station apparatus from the plurality of terminal apparatuses for each subframe;
calculating smoothed channel quality information by smoothing the channel quality information received so far from the terminal apparatus for each terminal apparatus; and
storing the calculated smoothed channel quality information in association with an ID of each of the plurality of terminal apparatuses.

12. A communication quality estimation program for causing a computer to execute:
receiving channel quality information indicating channel quality in transmission paths between a plurality of terminal apparatuses and a base station apparatus from the plurality of terminal apparatuses for each subframe;
calculating smoothed channel quality information by smoothing the channel quality information received so far from the terminal apparatus for each terminal apparatus; and
storing the calculated smoothed channel quality information in association with an ID of each of the plurality of terminal apparatuses.
